(19) United States
(12) Patent Application Publication
(10) Pub. No.: US 2020/0134852 A1
(43) Pub. Date: Apr. 30, 2020

(54) THREAT WARNING SYSTEM

(71) Applicant: BAE SYSTEMS INFORMATION AND ELECTRONIC SYSTEMS INTEGRATION INC., Nashua, NH (US)

(72) Inventor: Michael N. Mercier, Nashua, NH (US)

(21) Appl. No.: 16/174,525

(22) Filed: Oct. 30, 2018

(51) Int. Cl. G06T 7/70; F41H 11/00; G06T 7/00; G01S 5/18; G01J 1/42; G06F 17/11; H04W 4/029

(52) U.S. Cl. CPC G06T 7/70; F41H 11/00; G06T 7/0002; H04W 4/029; G01J 1/42; G06F 17/11; G01S 5/18

(57) ABSTRACT

The present disclosure provides a threat warning system that utilizes an image sensor and an active radar to determine whether a muzzle flash is the source of a threat to a platform carrying the threat warning system. The threat warning system may be a new operation of existing or legacy components on a platform that are implemented as a software update to accomplish the new objectives of the present disclosure. Alternatively, the components described herein may be provide as a newly constructed group of components networked together to accomplish the intended functions of the present disclosure.

### TECHNICAL FIELD

The present disclosure relates generally to a threat warning system on a platform. More particularly, the present disclosure relates to a threat warning system on a platform that utilizes imagery detecting a flash and a radar to determine whether an object is a threat to the platform.

### BACKGROUND INFORMATION

There is no shortage of potential threats in our world. With respect to moving platforms, such as aircraft, shipping vessels and ground-based vehicles, threats, such as incoming projectiles, can be critical. Various projectiles, including rockets, missiles, drones, and similar weapons, can easily damage or destroy these platforms.

With respect to aircraft, while the threat applies to commercial aircraft, the problem is greater for military aircraft, such as fixed wing and rotary wing aircraft. Aircraft in this context includes airplanes, jets, helicopters, rotorcraft, gliders, unmanned aerial vehicles, manned aerial vehicles, rockets, missiles, satellites, spacecraft, and similar platforms. Previously, the types and numbers of threats, such as those faced by military aircraft, were linear and it was possible to incorporate appropriate countermeasures. Unfortunately, the vast array of technologies has increased the potential threats such that countermeasure techniques of the past may not be fully equipped to handle those of the future with multiple simultaneous threats, different types of threats, and new emerging threats developing at an exponential rate. Currently, threat warning sensors, which are designed to mitigate the impact of such threats by providing a warning, allowing those in danger to take appropriate action are primarily passive imagers that scan for electro-optical and infrared (EO/IR) emissions and then analyze those emissions to determine whether or not the source is a threat. This determination is generally based on a correspondence of real world data to threat models programmed into the system.

Previous systems typically used prior knowledge of threat motor profiles to train and develop algorithms in order to identify the same. While the threat motor profiles have certain advantages, they are not without some drawbacks. For example, using the motor profile of the threat requires that the threat be in motion before it may be detected by the warning system on the platform.

### SUMMARY

Issues continue to exist with current warning systems inasmuch as they require first to determine that the threat is moving before it may be evaluated. Thus, a need continues to exist to evaluate and determine whether a threat is present before the motor profile is evaluated by the warning system. The present disclosure addresses these and other issues by providing an early onset threat warning system that evaluates electro-optical or infrared profiles of a flash of light, such as a muzzle flash from a firing platform, for example, a gun barrel, to determine whether the object fired from the firing platform is a threat to the platform. One exemplary embodiment of the present disclosure utilizes a passive sensor to observe or otherwise detect a flash from a muzzle. Then, a signal is generated in response to the sensor detecting the muzzle flash. This signal is then provided to the radar to determine whether there is an object traveling towards the platform.

In another aspect, and exemplary embodiment of the present disclosure may provide a threat warning system comprising: a sensor on a platform to detect a muzzle flash from a source occurring remotely from the platform; a signal generator in operative communication with the sensor that generates a signal in response to the sensor detecting the muzzle flash; a radar on the platform that receives the signal from the signal generator to cue or point a radar beam generated by the radar towards the source of the muzzle flash; and object detection and tracking logic in operative communication with the radar to detect an object moving through the radar beam and to determine whether the object is a threat to the platform. This exemplary embodiment or another exemplary embodiment may further provide signal generation logic in communication with the signal generator that evaluates intensity characteristics of the muzzle flash from the source that is remote from the platform. This exemplary embodiment or another exemplary embodiment may further provide signal generation logic in communication with the signal generator that evaluates spectral characteristics of the muzzle flash from the source that is remote from the platform. This exemplary embodiment or another exemplary embodiment may further provide signal generation logic in communication with the signal generator that evaluates temporal characteristics of the muzzle flash from the source that is remote from the platform. This exemplary embodiment or another exemplary embodiment may further provide signal generation logic in communication with the signal generator that evaluates flash characteristics of the muzzle flash from the source that is remote from the platform. This exemplary embodiment or another exemplary embodiment may further provide signal generation logic in communication with the sensor to determine whether the muzzle flash is a flash-of-interest or an errant muzzle flash. This exemplary embodiment or another exemplary embodiment may further provide an inertial measurement unit (IMU) on the platform that calculates the geolocation of the source of the muzzle flash. This exemplary embodiment or another exemplary embodiment may further provide bearing calculation logic in operative communication with or in the object detection logic to calculate the bearing of the object moving through the radar beam. This exemplary embodiment or another exemplary embodiment may further provide wherein the sensor on the platform is a passive sensor. This exemplary embodiment or another exemplary embodiment may further provide wherein the passive sensor is one of an infrared (IR) sensor and an ultraviolet (UV) sensor. This exemplary embodiment or another exemplary embodiment may further provide wherein the source of the muzzle flash is one of a gun, a turret, a surface-to-air rocket launcher, a man-portable air defense system (MANPAD), and tank.

In yet another aspect, an exemplary embodiment of the present disclosure may provide a method comprising: sensing, with a sensor on a platform, a flash occurring remotely from the platform; generating, with a signal generator, a signal indicative of the flash; providing the signal to a radar on the platform; directing, from the radar, a radar beam towards a source of the flash; detecting, with object detection and tracking logic, an object moving through the radar beam; tracking, with the object detection and tracking logic, the object; and determining whether the object is a threat to the platform. This exemplary embodiment or another exemplary embodiment may further provide deploying at least one countermeasure from the platform in response to the determination that the object is a threat to the platform. This exemplary embodiment or another exemplary embodiment may further provide maneuvering, evasively, the platform in response to the determination that the object is a threat to the platform. This exemplary embodiment or another exemplary embodiment may further provide wherein the flash is a muzzle flash produced from a firing platform; and sensing, with the sensor, an electro-optical or infrared (EO/IR) signature of the muzzle flash. This exemplary embodiment or another exemplary embodiment may further provide sensing, with the sensor, an intensity characteristic of the muzzle flash; generating, with the signal generator, the signal that includes the intensity characteristic of the muzzle flash. This exemplary embodiment or another exemplary embodiment may further provide sensing, with the sensor, a spectral characteristic of the muzzle flash; generating, with the signal generator, the signal that includes the spectral characteristic of the muzzle flash. This exemplary embodiment or another exemplary embodiment may further provide sensing, with the sensor, a temporal characteristic of the muzzle flash; and generating, with the signal generator, the signal that includes the temporal characteristic of the muzzle flash. This exemplary embodiment or another exemplary embodiment may further provide determining, with a device carried by the platform, a geolocation of the source of the muzzle flash. This exemplary embodiment or another exemplary embodiment may further provide determining, with bearing calculation logic, a bearing of the object moving from the geolocation of the source.

In another aspect, the present disclosure may provide a threat warning system that utilizes an image sensor and an active radar to determine whether a muzzle flash is the source of a threat to a platform carrying the threat warning system. The threat warning system may be a new operation of existing or legacy components on a platform that are implemented as a software update to accomplish the new objectives of the present disclosure. Alternatively, the components described herein may be provide as a newly constructed group of components networked together to accomplish the intended functions of the present disclosure.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 (FIG. 1) is a diagrammatic view of a platform carrying the threat warning system of the present disclosure around a hostile environment in which a field of view from a sensor is directed towards the ground.

FIG. 2 (FIG. 2) is a diagrammatic view similar to that of FIG. 1 depicting a radar beam being generated on the platform and directed towards the source of a threat.

FIG. 3 (FIG. 3) is an enlarged schematic view of the region labeled “SEE FIG. 3” in FIG. 2 depicting certain components of the threat warning system of the present disclosure.

FIG. 4 (FIG. 4) is a flowchart of a method of a threat warning system in accordance with one aspect of the present disclosure.

Similar numbers refer to similar parts throughout the drawings.

### DETAILED DESCRIPTION

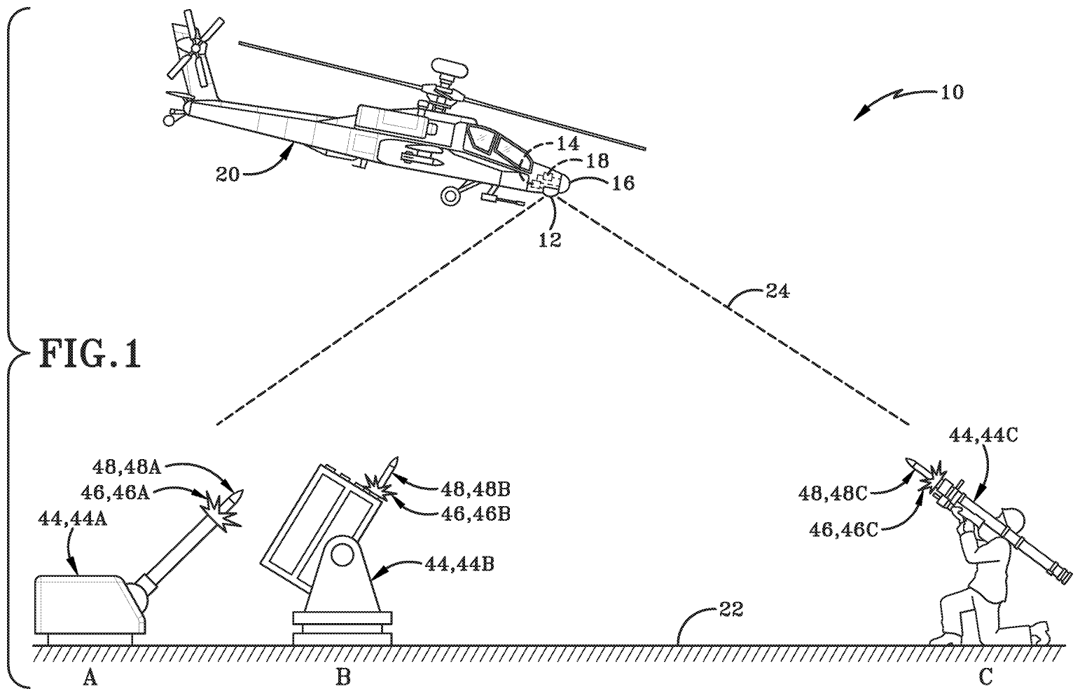

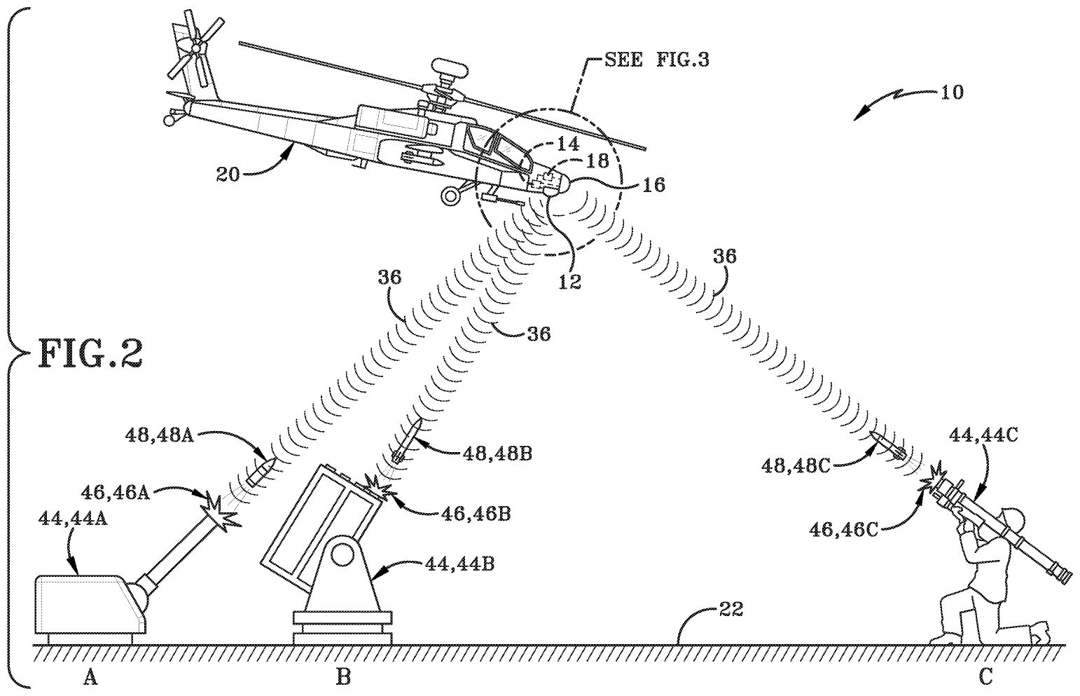

As depicted throughout FIG. 1 through FIG. 3, a threat warning system in accordance with certain aspects of the present disclosure is shown generally at 10. Threat warning system 10 may include a sensor 12, a signal generator 14, a radar 16, and object detection and tracking logic 18. Some portions of the system 10 may be carried by a platform 20.

In accordance with one aspect of the present disclosure, platform 20 may be any moveable vehicle configured to be elevated relative to a ground surface 22. When the platform 20 is implemented as a moveable vehicle, the moveable vehicle may be any aerial vehicle, such as a helicopter, rotorcraft, fixed-wing aircraft, unmanned aerial vehicle, satellite, space shuttle, or the like. Alternatively, it is further possible to implement certain aspects of the system 10 on a fixed platform 20. A fixed platform 20 would be elevated relative to the ground surface 22 and portions of the system 10, such as the sensor 12 and the radar 16, would be elevated relative to the ground surface to observe the same.

When platform 20 is embodied as a moveable aerial vehicle, the platform 20 may include a front end or a nose opposite a rear end or tail. Portions of the warning system 10 may be mounted to the body, the fuselage, or internal thereto between the nose and tail of the platform 20. While FIG. 1 depicts that some portions of the threat warning system 10 are mounted or carried by the platform 20 adjacent the nose of the platform 20, it is to be understood that the positioning of some components may be varied and the figure is not intended to be limiting with respect to the location of where the sensor 12 and the radar 16 are mounted on the platform 20. Furthermore, some aspects of the sensors 12 and radars 16 may be conformal to the outer surface of the platform 20 while other aspects of the sensor 12 or radar 16 may extend outwardly from the outer surface of the platform 20 and other aspects of the sensor 12 and the radar 16 may be internal to the platform 20.

Sensor 12 may be an optical sensor mounted on the lower side of the platform 20. Sensor 12 is configured to observe the ground surface 22 with its field of view 24. Inasmuch as sensor 12 has a field of view 24, in one particular embodiment, sensor 12 is an image sensor or imager. Further, when the sensor 12 is embodied as an imager, the imager may be an electro-optical imager. Even further, when the sensor 12 is an electro-optical imager, the imager may be an infrared (IR) or ultraviolet (UV) imager. The imager, or sensor 12, may be an active sensor or a passive sensor. However, certain aspects of the present disclosure are operative with the sensor 12 being a passive sensor 12. As will be discussed in greater detail below, the term “passive” with respect to the sensor 12 or the EO/IR/UV imager refers to the fact that the sensor 12 receives data observed through its field of view 24 of the ground surface 22, but does not transmit signals.

Furthermore, when the sensor 12 is embodied as an electro-optical imager, the imager will have some components that are common to image sensors such as lens, domes, focal plane arrays, and may additionally include processors and associated processing hardware. Towards that end, a reader of the present disclosure will understand that the sensor 12 may include standard imaging components adapted to sense, capture, and detect imagery within its field of view 24. The imagery may be in a spectrum that is not viewable to the human eye.

While the field of view 24 in FIG. 1 is directed downwardly towards the ground surface 22, it is further possible for a system in accordance with the present disclosure to have a sensor 12 that projects its field of view 24 outwardly and forwardly from the nose of the platform 20 or outwardly and rearwardly from the tail of the platform 20. It would even be further for the sensor 12 to be pointed upwardly and away from the ground surface 22. However, as will be described in greater detail below, certain implementations and embodiments of the present disclosure are purposely aimed downward so as to detect a source of a threat through the use of different flashes. Typically, the flashes 46 occur at or near the ground surface 22; however, it would be possible to observe flashes occurring above the aircraft if that were the case.

Generally, the sensor 12 has an input and an output. An input to the sensor 12 may be considered the image scene observed by the field of view 24 that is processed through the imagery or sensing components within the sensor 12. The sensor output is an image captured by the sensor 12 that is output to another hardware or processing component.

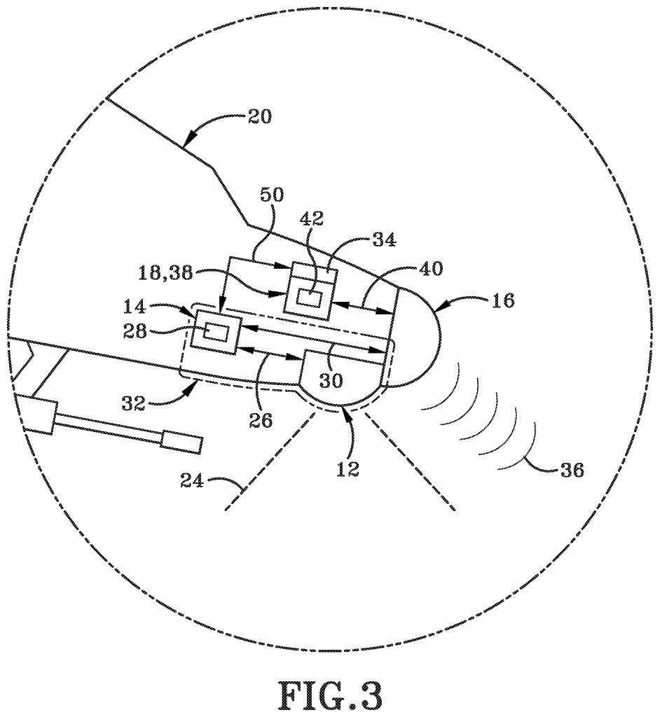

FIG. 3 depicts the signal generator 14 is in operative communication with the sensor 12. More particularly, the signal generator 14 is electrically connected with the output of the sensor 12. In one particular embodiment, the signal generator 14 is directly wired to the output of the sensor 12. However, it is equally possible for the signal generator 14 to be wirelessly connected to the sensor 12. Stated otherwise, link 26 electrically connects the sensor 12 to the signal generator 14 and may be any wireless or wired connection to effectuate the transfer of digital information or data from the sensor 12 to the signal generator 14. Signal generator 14 is configured to or is operative to generate a signal in response to the data received over the link 26 from the sensor 12. In some implementations, the data that is sent over the link 26 is the image captured by the sensor 12 that is observing the ground scene below through its field of view 24. As will be described in greater detail below, the signal generator 14 may include signal generation logic 28 which evaluates the image from the sensor 12. In accordance with one aspect of the present disclosure, the signal generation logic 28 evaluates the image from sensor 12 to look for muzzle flashes 46 or other flashes 46 occurring within the field of view 24. The signal generation logic 28 may include at least one non-transitory computer readable storage medium that, which executed by one or more processors, implements operations to determine whether the flashes 46 detected by the sensor 12 fall within a spectral characteristic of a known threat to the platform 20. For example, the storage medium of signal generation logic 28 may include a database of known spectral characteristics of different types of threats that produce muzzle flashes. For example, small arms, weapons fire, or munitions may produce a spectral signature of a muzzle flash when a projectile, such as bullet, is fired therefrom. Similarly, a tank or a surface to air missile launcher each produces unique spectral characteristics of muzzle flash when their respective munitions are fired. The spectral characteristics may be stored in the storage medium of the signal generation logic 28. Then, the processor within the signal generation logic 28 may evaluate the imagery captured from the sensor 12 against the known data base of spectral characteristics to determine whether the source of the muzzle flash or other electro-optical event is one that is known to be a potential threat to the platform 20. The manner in which the database of the signal generation logic 28 populates the list or bank of available spectral characteristics of potential threats may be prepopulated prior to platform flight. However, it is entirely possible for the database to be built in situ while the platform 20 is in motion. Certain aspects of this embodiment would require that evaluation logic is coupled with the signal generation logic 28 to enable the evaluation logic to observe the images sensed by the sensor 12. The, the evaluation logic may add or update to the database in the storage medium of the signal generation logic 28 to build upon other spectral characteristics of known threats and add to the database characteristics of observed threats as they are detected by the sensor 12.

The signal generator 14 and the signal generation logic 28 are electrical and operative communication with the radar 16 via link 30. Link 30 may be any electrical connection, which may be wired or wireless, that enables digital data transfer from the signal generator 14 to the radar 16. In one particular embodiment, the signal that is generated by the signal generator 14 is a cueing signal. Since the signal generator 14 may be used to generate a cueing signal, some aspects of the present disclosure may generally refer to the sensor 12 coupled with the signal generator 14 collectively as a threat cueing module. Even further, the threat cueing module is generally shown by dashed lines 32. Further, since the sensor 12, in one embodiment, is a passive sensor 12, the threat cueing module 32 may be considered a passive threat cueing module. Further, typically, sensor 12 takes two-dimensional images thus the cueing module 32 may be considered a two-dimensional (2D) passive threat cueing module 32.

Radar 16 includes an input that is in operative communication with the link 30 to receive the signal or cueing signal from the signal generator 14 of the threat cueing module 32. The cueing signal sent across link 30 includes instructions that direct the radar 16 to generate a radar beam 36 and direct its radar beam 36 towards a source of the muzzle flash observed in the image captured by the sensor 12.

The signal generator 14 and the radar 16 may be directly or indirectly coupled with an inertial measurement unit 34. The IMU may have GPS or other geolocation capabilities that enable the threat cueing module 32, and more particularly the signal generation logic 28, to determine the geolocation of the source of a muzzle flash 46 that is to be investigated or interrogated by the radar beam 36. The IMU 34 may be an existing hardware component on the platform 20. Thus, the connections and links with the signal generator 14 and the radar 16 may occur directly or indirectly through other existing legacy components of the platform 20.

Radar 16 is any type of radar that is able to direct or steer its radar beam 36 towards a remote location from the platform 20. However, as will be described in greater detail below, one exemplary aspect or version or radar 16 is an active radar that steers its beam 36 towards the geolocation of the source of the muzzle flash 46 to determine and observe whether an object, such as a fast moving projectile, is moving through the radar beam 36. Radar 16 is coupled with object detector and tracker 38 in the objection detection and tracking logic 18 via a link 40, which may be a wired or wireless link. The results of the radar 16 are provided across link 40 to the object detector and tracker 38. The object detector and tracker 38 is configured to detect the presence of a fast moving object, such as a projectile, moving through the radar beam 36. Further, certain aspects of the tracking of the object detector and tracker 38 may track the fast moving object through the radar beam 36.

Bearing logic 42 is in operative communication with the object detector and tracker 38. Bearing logic 42 includes processing components that are configured to determine the bearing of the object that is detected and tracked by the object detector and tracker 38. The bearing logic 42 or another logic of system 10 may evaluate whether the object is moving towards the platform 20. In the event the object is moving towards the platform 20, the bearing logic 42 or another logic of system 10, such as a warning logic (not shown) may determine that the object is a threat.

With continued reference to FIG. 1, and having thus described the general structure of system 10, reference is now made to the sources of the threats. More particularly, threats are generally shown on the ground surface 22. Specifically, a threat may include a firing platform 44 that produces a muzzle flash 46 when propelling an object 48. For example, there may be a first firing platform 44A that produces a first muzzle flash 46A while propelling or firing an object 48A from the firing platform 44A. In this non-limiting example, the first firing platform 44A, which may also be referred to as track “A” may be a machine gun or a turret that produces a muzzle flash 46A when firing its projectile, such as a bullet 48A, into the air. The first firing platform 44A may be aimed towards the platform 20 to propel the bullet 48A towards the platform 20.

A second firing platform 44B may be in the form of a surface-to-air rocket launcher producing a muzzle flash 46B to propel its projectile 48B towards the platform 20. Generally, this type of threat may be considered as track “B.” Further, a third threat may include a firing platform 44C, which may be embodied as a man portable rocket launcher or grenade launcher, that produces a muzzle flash 46C when launching its projectile 48C in the form of a rocket towards the platform 20. As will be described in greater detail below, system 10 is configured to utilize the sensor 12 and the radar 16 to cooperate to track the objects 48 fired towards the platform 20 based on spectral signatures of their respective muzzle flashes 46. Because the sensor 12 is passively observing the muzzle flashes 46, the system 10 is able to more rapidly detect, observe, and determine whether the objects 48 moving towards the platform 20 are threats thereto through the use of observing the muzzle flashes 46 rather than simply using a radar beam 36 to scan for fast-moving objects. Thus, aspects of system 10 may provide advanced warning or may provide earlier warning of a threat, such as an object 48 moving towards the platform 20 configured to destroy the same.

Having thus described the exemplary structural configuration of some aspects of the system 10, reference will now be made to the operation in which the system 10 uses the sensor 12 to detect a muzzle flash 46 from a source or firing platform 44 occurring remotely from the platform and the use and operation of a signal generator 14 that generates a signal in response to the sensor 12 detecting the muzzle flash 46. Then, the operation of the radar 16 that receives the signal from the signal generator 14 to point or steer its radar beam 36 towards the source or firing platform 44 of the muzzle flash 46. Then, the use and operation of the object detection and tracking logic 38 that determines whether the object or projectile 48 moving through the radar beam 36 is a threat to the platform 20.

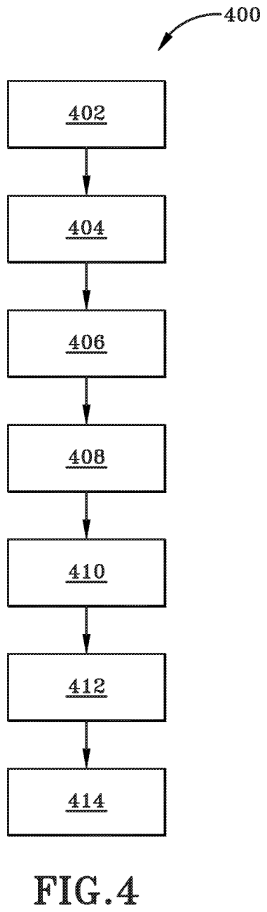

FIG. 4 depicts a method in accordance with one aspect of the present disclosure generally at 400. The method 400 may include sensing with the sensor 12 on the platform 20 and the flash 46 occurring remotely from the platform 20, which is shown generally at 402. Method 400 may further include generating with the signal generator 14 the signal that is indicative of the flash 46, which is shown generally at 404. Method 400 may include providing the signal to the radar 16 on the platform 20, which is shown generally at 406. The method 400 may include directing from the radar 16, the radar beam 36 towards the source (such as gun barrel 44) of the flash 46, which is shown generally at 408. Method 400 may further include detecting with object detection and tracking logic 18 an object, such as projectile or munition 48, moving through the radar beam 36, which is shown generally at 410. Method 400 may further include tracking with the object detection and tracking logic 18 the object 48, which is shown generally at 412. Method 400 may further include determining whether the object 48 is a threat to the platform 20. Additional aspects of method 400 may include deploying at least one countermeasure from the platform 20 in response to the determination that the object 48 is a threat to the platform 20. Further, method 400 may include maneuvering evasively or in an evasive manner the platform 20 in response to the determination that the object 48 was a threat to the platform 20. Other aspects of the method 400 may provide that when the flash 46 is a muzzle flash produced from a firing platform 44 that using the step of sensing with the image sensor 12 an electro-optical or an infrared (EO/IR) signature of the muzzle flash 46. As discussed above, the sensor 12 senses different characteristic of the muzzle flash 46. For example, method 400 may provide sensing with the sensor 12 an intensity characteristic of the muzzle flash 46 and generating, with the signal generator 14, the signal that includes the intensity characteristic of the muzzle flash 46. Alternatively, method 400 may provide sensing with the sensor 12 a spectral characteristic of the muzzle flash 46 and generating with the signal generator 14 the signal that includes the spectral characteristic of the muzzle flash 46. Even further, method 400 may provide sensing with the image sensor 12 a temporal characteristic of the muzzle flash 46 and generating with the signal generator 14 the signal that includes the temporal characteristic of the muzzle flash 46.

Inherent to the determination of the bearing of the object 48 moving towards the platform 20, the method 400 may include determining with a device carried by the platform 20, such as the IMU 34, a geolocation of the source (firing platform 44) of the muzzle flash 46. The method 400 may further include the step of determining with bearing calculation logic 42 a bearing of the object 48 moving from the geolocation of the source of the muzzle flash 46.

The logics described herein may include filters to block or remove background noise and other unwanted data. Such equipment may also include processors to match the detected acoustic data to known or expected acoustic profiles. Such equipment may also include processors to perform calculations to determine the angle of arrival (“AOA”) and time of arrival (“TOA”) of the ordnance or object 48. Such equipment may also include signaling electronics to deliver the detected and calculated data to the vehicle operator and/or other personnel of the platform 20. The system 10 may make use of alarming equipment already on board the platform 20, such as that associated with the Common Missile Warning System (CMWS). The electronic logic may also be positioned within the housing of the sensor 12. Thus, the entire inventive system is small and light, weighing only a few pounds, minimizing installation and operational burden to the platform 20.

After the EO/IR image data is sensed/measured by sensor 12, it may processed or filtered, to remove background noise. This may be accomplished by the signal generation logic 28. One source of background noise is the errant flashes generated by other light sources near the ground or otherwise remote from the platform 20. An exemplary source of background noise is gun fire, caused by ground troops, fighting with an enemy wherein the bullets from the ground troops are not directed towards the platform 20. Thus, the image sensor should be selected or adjusted to minimize this background image noise source as much as possible.

The processed signal may be then correlated or convoluted. This is also known as match filtering and compares the processed signal to known or expected image profiles for muzzle flashes of munitions or ordnance to further remove background image noise such as statistical scatter from the data. The result of this convolution process is a substantially clear image signal of the muzzle flash from which the radar may be cued such that radar object detection calculations can be made.

In one example, a Doppler effect of the radar beam 36 may utilize differences in timing to indicate from which direction the projectile or object 48 came and whether the projectile is moving towards the platform 20. Thus, the direction to the weapon and shooter is determined with the assistance of the data provided by the IMU 34. The method and system derives the direction from the separate times through the radar beam 36.

In one particular embodiment, the passive sensor 12 is an imager or camera observing the scene around the platform and is trying to detect flashes 46 coming from a muzzle, firearm, or firing platform 44. The sensor 12 may be in the UV range or the IR range of wavelengths. In this exemplary embodiment, the sensor 12 is considered passive because it does not emit. Stated otherwise, the sensor is not emitting energy or radiation, rather it is simply observing and detecting the scene around the platform. Thus, the radar may be considered an active radar system because when the signal that is generated in response to the passive sensor is sent to the radar, the radar emits electromagnetic radiation or waves to determine whether an object is moving towards the platform.

In one particular embodiment, the passive sensor may be part of an existing or legacy system on the platform. For example, there is a CMWS system on platform 20 which already include a passive sensor 12, such as an IR sensor or UV sensor. There may also be Limited Interim Missile Warning System (LIMWS) systems which may include an IR sensor or a UV sensor which may operate as the passive sensor of the present disclosure. The CMWS and the LIMWS are missile-warning systems that include various features upon which the present disclosure advances.

In accordance with another aspect of the present disclosure, the system or assembly may be provided as an add-on or supplemental kit that enhances or otherwise supplements an existing threat-warning system or threat-warning sensor. Thus, aspects of the present disclosure may be generally referred to as a threat-warner that simply is installed through software code via an update to existing legacy hardware on the platform 20. Stated otherwise, the present disclosure provides a threat-warning system that uses an existing imager that is passively staring at the environment around the platform and updates the code or instructions controlling the same to perform additional functions. This code or instructions may reflect the portion of the present disclosure that is added to the existing threat-warning system that communicates with the radar that confirms whether there is metal in the air moving towards the platform subsequent to a muzzle flash 46 detected by the sensor in the warning system.

The radar may be any radar existing on the platform. In one particular embodiment, the radar may be a separate hardware device that is installed on the platform to supplement portions of the platform with another hardware component. However, it is entirely possible that it would be advantageous to maintain or otherwise reduce size, weight, power, and cost (SWaP-C) requirements by using an existing legacy radar on the platform to cooperate with the threat-warning system 10, namely, the sensor, to achieve the exemplary advantages of the present disclosure.

One exemplary radar system is found in U.S. patent application Ser. No. 15/963,505, filed on Apr. 26, 2018, which claims priority from U.S. Provisional Patent Application Ser. No. 62/490,353, filed on Apr. 26, 2017, both of which are commonly owned by the Assignee at the time of filing.

The threat warning system 10 of the present disclosure may also be considered a three dimensional (3D) tracking and warning system. The sensor generates the signal in response to observing the muzzle flash based on a combination of intensity and spectral characteristics and temporal characteristics and features that determine that the flash detected by the sensor might be a weapon. The spectral characteristics and temporal characteristics and intensity identify that the flash 46 may be considered a flash of interest. When the sensor determines that the flash may be a flash of interest, then the signal generator 14 generates a signal regarding the flash of interest.

After determining that there is a flash of interest, the 3D tracking and warning system 10 determines the location of the flash with the IMU 34 on the platform. Namely, the IMU 34 uses azimuth and elevation along with additional features, such as attitude of the platform 20, to geolocate the source of the flash of interest. In one particular embodiment, this may be accomplished by an existing or legacy IMU 34 on the platform 20. Once the location of the flash source has been determined by the IMU, a signal carrying data of the geolocation of the flash of interest is sent across link 50 to the signal generator which provides the same to the radar 16. The signal sent along link 30 directs the radar to inspect or investigate the source of the muzzle flash. Stated otherwise, the signal sent from the signal generator 14 to the radar 16 directs or cues the radar to point its radar beam 36 to the geolocation or the source of the muzzle flash. Stated otherwise, the radar 16 interrogates the geolocation of the source of the muzzle flash 46.

Subsequent to directing the radar beam towards the geolocation of the source of the muzzle flash, the radar is then able to determine the direction in which the objects fired from the muzzle flash are moving. Based on the movement of the object, such as a piece of metal or object 48, the radar can then determine through the radar beam whether the object is moving towards or away from, or in another direction relative to the platform. Stated otherwise, the radar is able to determine the bearing of the object moving through the radar beam that is pointed towards the source of the muzzle flash. The bearing calculation of logic 42 used to determine the bearing of object 48 moving through the radar beam may be a standard bearing calculation or algorithm as one having ordinary skill in the art would recognize. For example, the bearing algorithm used to determine the bearing of the object 48 moving through the radar beam 36 would take into account a waveform configured to identify the bearing of a moving object. Further, the calculations in the bearing computations would need to account for the fast moving objects moving through the radar beam. In some implementations, the bearing calculations or bearing waveform calculations needed for fast moving objects moving through the radar beam need to account for assumptions that determine Doppler measurements of the return of the radar signal.

The system 10 of the present disclosure determines whether “you are the one” or “you are not the one” (YATO/YANTO) that the projectile or object moving through the radar beam is moving towards. Stated otherwise, the radar 16 determines whether the object 48 moving through the radar beam 36 is observed or detected in response to the muzzle flash 46 is moving towards the platform or in another direction relative to the platform that is a non-harmful direction. Thus, some examples when it is determined that the platform “is not the one” that the object is moving towards may be that the muzzle flash relates to small arms fire occurring on the ground or may relate to other munition fire or rounds that are moving in different directions that are not a threat to the platform.

In the event that the radar 16 determines that “you are the one” that the object is moving towards, then the system 10 provides this information to the platform 20 or pilot to determine how to take appropriate actions. For example, countermeasure systems may deploy countermeasure munition fire to intercept and intervene or otherwise destroy the object 48 moving towards the aircraft. Alternatively, evasive maneuvers may be executed in response to the determination that “you are the one” and the object is moving towards the platform. In other situations, a warning may be provided to the pilot to indicate that he is being shot at. There may be automated countermeasure systems that may intercept the hostile fire shot towards the platform. In accordance with one aspect of the present disclosure, the system may be beneficial in one exemplary embodiment to be used with munition rounds that are fired that do not have an incendiary tracers because this will work with any type of gunfire, whereas existing warning systems operate more efficiently when incendiary tracking rounds are fired. Stated otherwise, the system of the present disclosure relies on the optical emissions of the muzzle flash and does not require or rely upon other optical emissions of the munition round moving from the source of the muzzle flash towards its target. Stated further otherwise, the object may be a bullet or another object that does not emit photons as it leaves the firing platform or gun barrel (such as bullets with tracers or missiles with motor burn).

Further, while the platform examples provided herein are specific to aircraft, including rotary wing aircraft, the technology described is portable to other platforms, such as marine, land, space, and other vehicles. Also, active radar 16 is herein used to describe a radar component that outputs RF energy and may be contrasted with passive radar, which merely detect RF energy in an operating environment.

Another embodiment of the threat warning system of the present disclosure combines a passive imager with an active sensor that can confirm if an EO/IR source, such as a muzzle flash 46, is actually a threat to the platform. For example, a threat may be that a projectile or object 48 is heading in the direction of a platform. More specifically, embodiments utilize a passive sensor 12 to cue an electronically-steerable RF emitter of radar 16 to interrogate an area and determine if there is a threat. The electronically-steerable RF emitter of radar 16 then tracks fast-moving objects and determines their speed and range to the platform 20. The effectively expands the 2 dimensions that prior art system, which only utilized passive sensors, look in (azimuth, elevation) and adds a 3^{rd} dimension (range). Among the benefits of this solution is that it allows the passive sensor's thresholds to be relaxed and more generic, relying on the steerable RF emitter to confirm the threat and prevent excessive false alarms, saving precious, consumable countermeasure solutions, such as flares.

The passive threat cueing module 32 then provides these cues or signals to the 3D agnostic object detection and tracking logic 18 for further tracking and confirmation of the potential threats. In one example, active radar, which is a component of the 3D agnostic object detection and tracking logic 18, provides threat position and velocity with low false alarm rate. Active radar 16, in some embodiments, comprises laser, direct RF emitters, and similar technologies to provide detection and tracking functionality. Based upon the results returned by the 3D agnostic object detection and tracking logic 18 and its associated active radar 16, instructions and guidance are provided to a layered agnostic countermeasures module on platform 20. The layered agnostic countermeasures module, in embodiments, include Common Infrared Countermeasures (CIRCM), flares, combined lasers/flares, advanced laser, hard kill, as well as unconventional countermeasures.

One feature of embodiments of the present disclosure is to add a threat-agnostic discrimination capability to current threat detection systems that can simultaneously lower the false alarm rate and increase the probability of detection for both known/exploited and unknown/unexploited threats. In embodiments, the passive threat cueing module 32 cues the 3D agnostic object detection and tracking logic 18 when a potential threat is detected from a muzzle flash 46, or another EO/IR source, and the 3D agnostic object detection and tracking logic 18 then confirms or denies the presence of a threat (e.g. object 48) approaching the platform 20 using its active radar 16 component. Said another way, the passive threat cueing module 32 detects a potential threat with an agnostic cue-only thread, which may be based on muzzle flash 46, the 3D agnostic object detection and tracking logic 18 interrogates and detects the threat or object 48 approaching the platform 20, and the layered agnostic countermeasures component declares a track and allocates appropriate countermeasures. Under some conditions, potential threat tracks (such as track A, track B, and track C) generated by multiple muzzle flashes 46A, 46B, 46C, respectively, on the ground are investigated simultaneously and the 3D agnostic object detection and tracking logic 18 supports cycling between multiple threats in an operationally relevant timeline. Unknown threats may be confirmed by the response picked up by the active radar. In embodiments, this functionality is enabled through the use of a Metamaterial Electronically Steerable Array (MESA) acting as the active radar component of the 3D agnostic object detection and tracking logic 18.

In one particular embodiment, there may be signal clutter that appears threat-like to the 2D passive threat cueing module 32. Such clutter, in embodiments, is rejected if the 3D agnostic object detection and tracking logic 18 fails to find a matching RF response in the vicinity. For example, following the passive threat cueing module detecting a potential threat (clutter), it cues the 3D agnostic object detection and tracking logic 18 that then interrogates and detects nothing in the expected range and Doppler. Given this information, the 3D agnostic object detection tracking logic 18 (e.g., a detector and tracker 38) decides the track, such as Track A or Track B or Track C, is clutter and does not direct the layered agnostic countermeasures module to allocate countermeasures.

Some aspects of the present disclosure may function to assist in the correct allocation of Directional Infrared Counter Measures (DIRCM) in the presence of multiple potential threats. In this example, the 2D passive threat cueing module 32, using the passive sensor 12, detects multiple potential threats based on a plurality of muzzle flashes 46 remote from the platform, such as threats at tracks A, B, and C producing muzzle flashes 46A, 46B, and 46C, respectively, at long range. DIRCM is then allocated to track A from a first muzzle flash 46A. The 3D agnostic object detection and tracking logic 18, using or implanting active radar 16, then begins interrogating each track (A, B, and C) in a cycle, in embodiments spending 100 ms (e.g., dwell time) on each track. The 3D agnostic object detection and tracking logic 18 then confirms one track originating from a muzzle flash is an actual threat. DIRCM on platform 20 is then immediately reallocated to the actual threat.

A further feature of embodiments of the present disclosure is to perform threat detection in the absence of a passively-detected potential threat in the form of a muzzle flash or another EO/IR event. To perform such threat detection, the 3D agnostic detection and tracking module scans an area around the platform continuously, regularly, or randomly for the presence of a threat in the form of muzzle flash or another EO/IR event; this technique is herein referred to as a volume search. The area in which a volume search is conducted, in embodiments, is selected by the 2D passive threat cueing module 32. A volume search is preferred in high clutter to poor contrast areas that reduce the 2D passive threat cueing module's potential for successful detection. Alternatively, an external source, such as a Laser Warning Receiver or other system, may cue a volume search. Regardless of the source of the area selected, the 3D agnostic object detection and tracking logic 18 may execute a volume search of this area independently of 2D passive threat cueing module 32, enabling the detection of threats that may elude other sensor (e.g., threats having no significant IR signature). In embodiments, the 3D agnostic object detection and tracking logic 18 continues scanning the area until a threat is found or the entire area is scanned, wherein the threat may be in the form of a muzzle flash 46. Some embodiments, however, may conduct repeated scans of an area of interest. In one example, a muzzle flash 46 near the platform 20 having an EO/IR signature indicative of a threat is found during the volume search, following which the 3D agnostic object detection and tracking logic 18 may track an object originating from the muzzle flash. Some embodiments, using a Missile Warning System (MWS), declare the object sourced from the muzzle flash is a threat and directs the layered agnostic countermeasures module to dispense flares or other countermeasure efforts. The MWS, in embodiments, is a component of the 3D agnostic detection and tracking module.

In some embodiments, the MWS is a component of the 2D passive threat cueing module 32 and has access to Digital Terrain Elevation Data (DTED) information describing where threats may appear. In such embodiments, a full area of interest can be defined based on range and knowledge of the position of the horizon, after which a volume search may be performed by the 3D agnostic detection and tracking module on this full area.

In some embodiments, threat information used for discrimination and reported by the active radar 16 contains range to the threat object 48 or the threat source (i.e., muzzle flash 46), bearing of the threat object or the threat source, and the velocity of the threat object 48 or the threat source relative to the platform 20. For agnostic threat confirmation, the accuracy of these measurements must be sufficient to facilitate proper threat discrimination, which depends on the threat. Range information is also used for timing of flare dispense or reallocation of DIRCM to a closer threat in a multi-threat scenario.

The time it takes to steer the RF beam 36 used by the active radar 16 is herein referred to as slew time and has an impact on performance, not only in determining how quickly a new threat can start being interrogated, but also whether or not the system has the ability to cycle between multiple threats in a single quadrant. Using a MESA, slew time is almost nonexistent since the array is electronically steered, enabling simultaneous investigation of threat tracks and the tracking of multiple targets.

Problematically, passive sensors in the operating environment can pick up RF energy emitted by active radar. In embodiments, provisions are made to ensure a low probability of detection (LPD), i.e., a low probability that a passive system, such as a Radar Warning Receiver (RWR), can detect the presence of the platform. A LPD also makes it unlikely that the outgoing signal can be intercepted (i.e., it has a Low Probability of Interception, or LPI), characterized, and used against the host platform, such as for jamming or spoofing.

Now regarding radar design considerations, minimizing SWaP-C is of particular importance on airborne installations. In embodiments, 4-5 active radars may be required to achieve coverage. In embodiments, the active radar acts as an adjunct to a passive threat cueing system, which is roughly the same size, weight, and power as existing Common Missile Warning Systems (CMWS). In embodiments, the platform integration for the active radar is to mount an active radar adjacent to each of a plurality of passive EO/IR sensors, allowing for a simple retrofit to existing legacy hardware and platforms.

Radar cross section (RCS), which is typically a function of frequency, is important to the maximum range performance of the active radar. Generally going to high frequencies improves RCS when smaller features of the target become relevant in relation to the size of the wavelength.

Threat velocity also impacts radar design, in at least a few ways. One impact is that higher threat velocity means a higher Doppler return on the incoming signal. This requires that the radar has a correspondingly higher receive bandwidth to handle it, which drives the selection of ADCs and the required processing power to perform signal processing (e.g., wider FFTs). This can also impact waveform selection. It also means that faster moving targets will have less timeline to allow for steering the beam and performing integration.

In some embodiments, the DIRCM has operational capability out to the maximum range of the 2D passive threat cueing module 32. In a scenario in which multiple tracks are present in a single hemisphere and the DIRCM can only be allocated to one, embodiments identify which of the tracks is a credible threat and the 2D passive threat cueing module then reallocates the DIRCM to that track.

Defining proper requirements for active tracking requires a full definition of the active protection scenario. Depending on the type of countermeasure and the threats that it must defeat, requirements can vary significantly. For example, a ballistic countermeasure has stringent requirements on bearing, velocity, and range whereas a daisy-cutter explosive charge requires accurate range and velocity, but not as accurate bearing. In embodiments, some countermeasure systems have their own tracking capabilities and require less accurate hand-off parameters. The type and lethality of the countermeasure determines how far from the aircraft the detonation must occur, which, in embodiments, drives the required range for the radar to achieve adequate performance levels.

In some embodiments, raw measurements from the radar may be provided to a Kalman filter or tracking algorithm. In such embodiments, the requirements on raw measurements would be dependent on that algorithm.

For example, bearing accuracy can, in many instances (depending on the threat list), be provided by passive sensors, such as IR sensors. This approach is used, in embodiments, when comparing the bearing estimation approach of the object launched from the EO/IR source to the active radar implementation.

Another consideration made in selecting a radar design is the radar waveform. In embodiments, the active radar uses either a pulsed or continuous-wave (CW) radar. Each has its advantages and disadvantages.

Pulse Doppler radars operate by generating RF pulses of energy at one or more Pulse Repetition Frequencies (PRF) and using both the time delay of the returning pulses and Doppler effects to estimate range, velocity, and filter the response from clutter. An advantage to using a pulsed approach is that the receiver can be isolated during the transmission of the pulsed energy, allowing for significantly higher output power to be used without compromising the detection ability of the receiver. The downside of this, however, is that to achieve the same average energy on target, significantly more energy must be put into the pulse compared to a CW waveform; average energy, not peak, is what matters. Furthermore, pulse Doppler radars do not typically have duty cycles exceeding 20%. This means that to achieve similar average power, the power of each pulse would be on the order of 5× that of an equivalent CW waveform.

The design of a pulse Doppler radar may introduce complications. The pulse width selected determines the minimum range of the radar as well as the size of any blind spots that arise during the periods where the receiver is blanked during transmit. To achieve the average power required for long-range targets, a long pulse width/high duty cycle is typically required, which would have a long blind-range. Embodiments switch between pulse widths, allowing dynamic changes to the blind-range. Depending on the PRF selection, there will also be ambiguities in either range, velocity, or both that are resolved by modulating the outgoing energy, such as by swapping between several different PRFs or introducing frequency modulation within pulses. In one embodiment, not all information can be known about the target until the entire cycle is complete and ambiguities are resolved.

CW radar simultaneously transmits and receives a continuous waveform and does not use time delay processing in the way that pulsed radars do for determining range. The frequency of the outgoing signal is modulated in some way (saw tooth, triangular, stepped, etc.) and the frequency of the returning signal can be used to determine range. CW radar benefits from more easily achieving higher average power, given the 100% duty cycle, but at the cost of having to remove echoes of the transmit signal from the receiver path (a process called “leakage cancellation”). In some embodiments, this is done by branching off the transmit signal and adding an equivalent echo signal onto the receive path with opposite phase and the same amplitude as the echo. CW radar also benefits from having no minimum detection distance, given that there is no blind-time during transmit, and range accuracy can be significantly higher than pulsed radar which has to match filter pulses and/or do range-binning.

The modulation pattern for a CW radar also has trade-offs. For the example of EO/IR muzzle flash 46 in surface-to-air missile threat confirmation, embodiments use the Doppler return alone to verify an object approaching the aircraft at a threat-relevant speed without any other information. In embodiments, an unmodulated single frequency is used to accomplish this. To better reject threats with speeds closer to that of moving platforms (e.g., rotor blades, etc.) and to support active protection capabilities, embodiments utilize a waveform that can accurately measure range and velocity, such as triangular modulation or multi-tone/stepped modulation.

In such embodiments, these frequencies may be transmitted simultaneously while in other embodiments, they are stepped through in a cycle with one frequency being transmitted at a time. Transmitting each frequency simultaneously achieves a high SNR as each tone is 100% duty cycle, but to do so requires individual amplifiers for each tone. Stepping through tones reduces SNR per frequency as they are no longer 100% duty cycle, but allows for a single amplifier chain to be used for all tones. Other embodiments step through tones and user the time delay of the frequency change to solve range ambiguity issues.

An advantage to using a multi-tone (stepped or simultaneous) waveform is that only the target Doppler has to be passed through the radar front-end. In a triangular or otherwise swept waveform, the bandwidth must also cover that required for the waveform modulation. Either FMCW approach requires converting the mixed and filtered data to digital and processing the data using a microprocessor in the back-end. By limiting the bandwidth to the small Doppler range, the back-end can be implemented with audio ADCs and a simple processor.

In one embodiment, a multi-tone CW approach is used. Multi-tone achieves similar performance to the FMCW, but with a much simpler design. A pulsed approach often requires more expensive amplifiers, while a CW approach could be implemented with COTS (Commercial, Off-The-Shelf) solid-state amplifiers. The simplicity of the back-end processing also factors into potential SWaP-C savings. A pulsed approach is preferable if the power required to achieve performance prohibits simultaneous transmit/receive (Tx/Rx) and the receiver must be blanked during transmit.

In some embodiments, Electronically Steerable Array (ESA) technology is used to allow for significant steering of the RF gain of the antenna (+/−45 to 60 degrees) with very fast slew times. In embodiments, ESA technology is implemented using an array of elements that are dynamically adjusted to control the directional gain of the antenna electrically without any moving parts. No mechanical parts required for the steering generally means a higher reliability and lower SWaP-C. ESA can be implemented in several ways: using phase shifters to adjust the incoming/outgoing phase at each element (PESA—Passive, Electronically-Scanned Array), by using separate solid-state transmit and receive elements that are controlled individually (AESA—Active, Electronically-Scanned Array) or by using metamaterial elements that can be activated and deactivated dynamically to adjust the outgoing/incoming surface wave (MESA). PESA approaches are generally too expensive for an application such as active radar. AESA approaches were previously too expensive to consider, but innovations with SiGe transistors are driving down the cost to competitive levels. MESA competes with existing AESA approaches, provides good performance, and is relatively cost-effective for this application.

Metamaterials, the materials used in MESAs, are artificial materials that can manipulate electromagnetic radiation in unique ways. MESAs have many of the desired operational performance characteristics for use as active radar 16. Small beam-width allows for an LPI radar design and high directional gain to achieve longer ranges. Fast steering allows for time-slicing between multiple tracks. Maximum steering angles allow for quadrant-level coverage by each MESA.

One embodiment of the present disclosure, for radar 16, uses a 24 GHz MESA antenna having a small, direction beam with high peak gain (>22 dBi) and a large enough field of regard to cover an entire quadrant. Another embodiment uses a 10 GHz MESA antenna and further embodiments include 33 GHz, 77 GHz and 94 GHz MESA antennas. In embodiments, tiles are combined to create a single larger-aperture antenna.

In some applications, a single transmit antenna is used with multiple receive antennas positioned in two orthogonal directions (L-shape). Such an approach not only allows for CW waveforms without leakage cancellation, but also allows for using phase interferometry on the received waveform to determine highly accurate bearing to the target. In an exemplary embodiment, a single MESA tile is used for Tx while 3 MESA tiles are used for Rx, providing a bearing accuracy of 0.1 degrees or better.

Now regarding frequency selection, there are several factors that go into frequency selection for the active radar 16. Higher frequency means higher atmospheric losses, particularly in rain, which makes the problem of reaching operational ranges much more difficult. At the same time, the higher atmospheric losses also help from an LPI perspective as excess signal and side lobes will not remain detectable over lesser distances. In embodiments, frequency may be changed to accommodate various applications, even within a single mission. For example, where significant range is not needed, frequencies are selected specifically because they reside in peaks on the atmospheric loss curve.

Now regarding conical scan and bearing accuracy, embodiments refine the bearing to the threat as determined by the passive threat cueing module. Along with range information, this allows for application of a hard-kill system as well as enables an active volume search for threats. Traditionally, determining bearing would use a mono-pulse radar design, however, to achieve low SWaP-C, embodiments utilize a conical scan approach to determine threat bearing. This reduces the number of antenna elements required to accurately locate the threats at the desired ranges.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures or grounded data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The indefinite articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral” and the like are used herein for the purpose of explanation only unless specifically indicated otherwise.

Although the terms “first” and “second”, or letter identifiers (i.e., Track A, Track B, and Track C) may be used herein to describe various features/elements, these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A method comprising:
sensing, with a sensor on a platform, a flash occurring remotely from the platform;
generating, with a signal generator, a signal indicative of the flash;
providing the signal to a radar coupled to the platform;
directing, from the radar coupled to the platform, a radar beam towards a source of the flash;
detecting, with object detection and tracking logic, an object moving through the radar beam;
tracking, with the object detection and tracking logic, the object; and
determining whether the object is a threat to the platform.

2. The method of claim 1, further comprising:
deploying at least one countermeasure from the platform in response to the determination that the object is a threat to the platform.

3. The method of claim 1, further comprising:
maneuvering, evasively, the platform in response to the determination that the object is a threat to the platform.

4. The method of claim 1, further comprising:
wherein the flash is a muzzle flash produced from a firing platform; and
sensing, with the sensor, an electro-optical or infrared (EO/IR) signature of the muzzle flash.

5. The method of claim 4, further comprising:
sensing, with the sensor, an intensity characteristic of the muzzle flash; and
generating, with the signal generator, the signal that includes the intensity characteristic of the muzzle flash.

6. The method of claim 4, further comprising:
sensing, with the sensor, a spectral characteristic of the muzzle flash; and
generating, with the signal generator, the signal that includes the spectral characteristic of the muzzle flash.

7. The method of claim 4, further comprising:
sensing, with the sensor, a temporal characteristic of the muzzle flash; and
generating, with the signal generator, the signal that includes the temporal characteristic of the muzzle flash.

8. The method of claim 4, further comprising:
determining, with a device carried by the platform, a geolocation of the source of the muzzle flash.

9. The method of claim 8, further comprising:
determining, with bearing calculation logic, a bearing of the object moving from the geolocation of the source; wherein the object does not emit photons while moving from the source.

10. A threat warning system comprising:
a sensor on a platform to detect a muzzle flash from a source occurring remotely from the platform;
a signal generator in operative communication with the sensor that generates a signal in response to the sensor detecting the muzzle flash;
a radar on the platform that receives the signal from the signal generator to cue or point a radar beam generated by the radar towards the source of the muzzle flash; and
object detection and tracking logic in operative communication with the radar to detect an object moving through the radar beam and to determine whether the object is a threat to the platform.

11. The threat warning system of claim 10, further comprising:
wherein the source is a gun barrel; and
wherein the object is a bullet that does not emit photos after being fired from the source.

12. The threat warning system of claim 10, further comprising:
signal generation logic in communication with the signal generator that evaluates intensity characteristics of the muzzle flash from the source that is remote from the platform.

13. The threat warning system of claim 10, further comprising:
signal generation logic in communication with the signal generator that evaluates spectral characteristics of the muzzle flash from the source that is remote from the platform.

14. The threat warning system of claim 10, further comprising:
signal generation logic in communication with the signal generator that evaluates temporal characteristics of the muzzle flash from the source that is remote from the platform.

15. The threat warning system of claim 10, further comprising:
signal generation logic in communication with the signal generator that evaluates flash characteristics of the muzzle flash from the source that is remote from the platform.

16. The threat warning system of claim 10, further comprising:
signal generation logic in communication with the sensor to determine whether the muzzle flash is a flash-of-interest or an errant muzzle flash.

17. The threat warning system of claim 10, further comprising:
an inertial measurement unit (IMU) on the platform that calculates the geolocation of the source of the muzzle flash.

18. The threat warning system of claim 10, further comprising:
bearing calculation logic in operative communication with or in the object detection logic to calculate the bearing of the object moving through the radar beam.

19. The threat warning system of claim 10, further comprising:
wherein the sensor on the platform is a passive sensor that is one of an infrared (IR) sensor and an ultraviolet (UV) sensor.

20. The threat warning system of claim 10, further comprising:
wherein the source of the muzzle flash is one of a gun, a turret, a surface-to-air rocket launcher, a man-portable air defense system (MANPAD), and tank.
